(19) United States
(12) Patent Application Publication
(10) Pub. No.: US 2026/0189650 A1
(43) Pub. Date: Jul. 2, 2026

(54) FOLDABLE MOBILE DEVICE CAMERA AND FACE DETECTION

(71) Applicant: Motorola Mobility LLC, Chicago, IL (US)

(72) Inventors: Ranjeet Gupta, Plainfield, IL (US); Rahul Bharat Desai, Hoffman Estates, IL (US); Philip Weinstein, Apex, NC (US)

(73) Assignee: Motorola Mobility LLC, Chicago, IL (US)

(21) Appl. No.: 19/004,870

(22) Filed: Dec. 30, 2024

(51) Int. Cl. H04M 1/72463; G06V 40/16; H04M 1/02; H04N 23/63; H04N 23/695

(52) U.S. Cl. CPC H04M 1/724631; G06V 40/166; H04N 23/632; H04N 23/695; H04M 1/0216; H04M 2250/12; H04M 2250/52

(57) ABSTRACT

In aspects of foldable mobile device camera and face detection, a mobile device includes a camera device to capture a facial image. The mobile device also includes a viewfinder of the camera device to display a preview of the facial image, and includes a position sensor to detect an orientation of the mobile device. The mobile device implements an image detection controller to detect that facial characteristics in the preview of the facial image will not support facial recognition. The image detection controller revises. based on the detected orientation of the mobile device, the preview of the facial image so that the facial characteristics will support the facial recognition.

### BACKGROUND

Devices such as smart devices, mobile devices (e.g., cellular phones, tablet devices, smartphones), consumer electronics, and the like can be implemented for use in a wide range of environments and for a variety of different applications. Generally, mobile devices come in varying sizes and form factors, such as rectangular with an overall rigid shape, foldable devices with a housing that is hinged allowing a device to fold, and slidable devices with housing sections that slide apart and back together. Consumers typically want smaller devices that are convenient to carry, yet also prefer devices that have some expandability for larger display viewing, such as with the foldable and slidable devices. Many of these mobile devices also include an integrated camera or camera system, such as for capturing digital images, selfie images, and/or for facial recognition to authenticate a user to a device for device and application access.

### BRIEF DESCRIPTION OF THE DRAWINGS

Implementations of the techniques for foldable mobile device camera and face detection are described with reference to the following Figures. The same numbers may be used throughout to reference like features and components shown in the Figures.

FIG. 1 illustrates an example mobile device for foldable mobile device camera, in accordance with one or more implementations as described herein.

FIG. 2 illustrates an example of facial recognition for foldable mobile device camera and face detection, in accordance with one or more implementations as described herein.

FIG. 3 further illustrates an example of a mobile device for foldable mobile device camera and face detection, in accordance with one or more implementations as described herein.

FIG. 4 illustrates an example of a mobile device for foldable mobile device camera and face detection, in accordance with one or more implementations as described herein.

FIG. 5 illustrates examples of revising an image preview for foldable mobile device camera and face detection, in accordance with one or more implementations as described herein.

FIG. 6 illustrates an example of revising an image preview for foldable mobile device camera and face detection, in accordance with one or more implementations as described herein.

FIG. 7 illustrate an example of revising an image preview for foldable mobile device camera and face detection, in accordance with one or more implementations as described herein.

FIG. 8 illustrates an example process flow for revising an image preview for foldable mobile device camera and face detection, in accordance with one or more implementations as described herein.

FIG. 9 illustrates an example method for foldable mobile device camera, in accordance with one or more implementations of the techniques described herein.

FIG. 10 illustrates an example method for foldable mobile device camera and face detection, in accordance with one or more implementations of the techniques described herein.

FIG. 11 illustrates an example method for foldable mobile device camera and face detection, in accordance with one or more implementations of the techniques described herein.

FIG. 12 illustrates various components of an example device that may be used to implement the techniques for foldable mobile device camera as described herein.

### DETAILED DESCRIPTION

Implementations of the techniques for foldable mobile device camera and face detection may be implemented as described herein. Although generally described in the context of a foldable mobile device or expandable mobile device, any type of a mobile device, wireless device, media device, mobile phone, flip phone, client device, tablet, computing, communication, entertainment, gaming, media playback, and/or any other type of computing, consumer, and/or electronic device may be configured to perform aspects of the techniques as described herein. In one or more implementations, a foldable mobile device includes at least one camera device and an image detection controller, which can be used to implement aspects of the techniques described herein for facial recognition.

Facial recognition is a technology used to detect a human face and compare a captured facial image, or the face as captured in a digital image or a video frame, against a database of faces. Facial recognition pinpoints and measures facial features in a given image, which can then be used to authenticate a user of a device based on biometric identification verification. Generally, a facial image of a user of a mobile device that is captured with a camera approximately straight-on to the face of the user is more likely to have detectable facial characteristics that align with a stored, comparative image, and is more likely to result in a successful facial recognition for authentication to biometrically unlock and access the device. Although generally described in the context of facial recognition, aspects of the techniques described herein may be equally applicable and implemented for iris recognition, which is also a form of biometric identification. As similarly described above, a facial image of a user of a mobile device that is captured with a camera approximately straight-on to the face of the user is more likely to have detectable eye characteristics that align with a stored, comparative image, and is more likely to result in a successful iris recognition for authentication to biometrically unlock and access the device.

Facial recognition and/or iris recognition can be hampered by a typical foldable mobile device that has a camera or cameras positioned at a lower corner location when the device is closed in a folded form factor. Given the position of the camera or cameras near the bottom edge of the outer display or housing of the device in the folded form factor of the device, the camera or cameras only have a narrow region-of-view. This can be problematic if a user is holding the device down at a lower angle, such as if the user takes the device out of his or her pocket and glances down to unlock the device using facial recognition. Given the upward, vertical angle and narrow region-of-view of a camera used to capture the facial image of the user of the device for facial recognition, the facial image may be only a vertical image, viewing upward at the bottom of the face of the user, which may not be adequate for facial recognition and/or iris recognition to authenticate the user and unlock the device. This authentication failure is likely due to facial and/or iris characteristics that are not detectable and cannot be matched to a comparative image for authentication, which leads to a poor user experience, as well as precludes the benefit of a seamless user experience. Similarly, selfie images are often captured at poor viewing angles and/or with a face of the user misaligned in a region-of-view of the camera due to the physical location or position of the cameras on a typical foldable device.

In aspects of the techniques described herein, a foldable mobile device has a main camera and/or an ultrawide camera, and the camera devices are located to face a user of the foldable mobile device as he or she holds the device in a position to view an outer, secondary display screen in a folded form factor of the device. In implementations, the camera devices are located in approximately the center along a top edge (e.g., from a user perspective) of the foldable housing of the device in the folded form factor of the device. Notably, a camera device located at the top edge of the foldable housing in the folded form factor of the foldable mobile device has a region-of-view conducive to capturing a facial image with facial characteristics that are detectable and usable for facial recognition and/or iris recognition. A user of the foldable mobile device can initiate facial recognition to access the device, which has the integrated one or more camera devices with a closed lid interface (CLI) camera sensor and facial unlock feature. The user of the device can use a camera device to capture a facial image, such as for facial recognition (or iris recognition) and authentication to biometrically unlock and access the device.

In aspects of the described techniques, a foldable mobile device implements the image detection controller, which can apply one or more techniques to revise an image preview of a facial image so that the facial characteristics and/or iris characteristics are detectable and will support facial recognition and/or iris recognition by a security module of the device. In implementations, the image detection controller can apply any one or a combination of a viewing angle adjustment, a preview zoom-in, and/or image post-processing to revise a facial image and increase detectability of the facial characteristics of the facial image for a successful facial recognition and/or iris recognition. The image detection controller can also apply the image post-processing based on an orientation of the foldable mobile device and/or the camera device, as detected by a position sensor. In implementations, the position sensor may be a gravity sensor, or other type of sensor or a combination of sensors (e.g., a gyro and accelerometer), that detect device alignment with Earth horizontal. In described aspects, the image post-processing is a planar angle shift to align, or approximately align, the viewing plane of a captured facial image for parallel comparison with a comparative image by the security module for the facial recognition and/or the iris recognition.

In further aspects of this disclosure, the image detection controller can detect that an image preview of a facial image may be misaligned in a region-of-view of the camera device, which will likely result in unsuccessful facial recognition (or iris recognition) by the security module. The image detection controller applies a viewing angle adjustment to adjust a viewing angle of the viewfinder (e.g., of the camera device and/or mobile device) so that the facial image is realigned in the viewfinder, which increases detectability of the facial characteristics for the facial recognition and/or the iris recognition. Additionally, or alternatively, the image detection controller can detect that the facial characteristics in an image preview of a facial image are too small for detection and successful facial recognition and/or iris recognition by the security module. The secondary, ultrawide camera device can then be used to capture an updated image preview of a facial image. With the wider field-of-view of the ultrawide camera device, the facial image is better aligned in the viewfinder so that the facial characteristics are detectable in the updated image preview of the facial image.

In further aspects of this disclosure, the image detection controller can detect that the facial characteristics in an image preview of a facial image are too small for detection and facial recognition or iris recognition, which will likely result in unsuccessful facial recognition or iris recognition by the security module. The image detection controller applies a preview zoom-in of the facial image, and the zoomed-in image preview increases detectability of the facial characteristics for the facial recognition and/or the iris recognition. In further aspects, the image detection controller can detect that the facial characteristics in an image preview of a facial image are too small for successful facial recognition or iris recognition by the security module. The secondary, ultrawide camera device can then be used to capture an updated image preview of a facial image. However, the updated image preview captured with the ultrawide camera device may still be detected by the image detection controller as having a facial image that is too small for successful facial recognition or iris recognition. Accordingly, the image detection controller applies the preview zoom-in for the updated image preview of the facial image so that the facial characteristics are detectable in the updated image preview of the facial image.

In further aspects of this disclosure, the image detection controller can detect that the facial characteristics of the face of a user in a captured facial image will not support facial recognition or iris recognition, such as due to a vertical angle of the image. Additionally, the image detection controller obtains or receives an indication of an orientation of the foldable mobile device and/or the orientation of the camera device, as detected by the position sensor, when the facial image is captured. The alignment of the facial image and the orientation of the device can be detected diagonally, horizontally, or vertically. In implementations, the image detection controller applies the image post-processing, such as based on the orientation of the foldable mobile device and/or the camera device, as detected by the position sensor, to increase detectability of the facial characteristics for the facial recognition and/or the iris recognition. The image detection controller applies the image post-processing to generate an updated facial image based on a planar angle shift to increase detectability of the facial characteristics for the facial recognition and/or the iris recognition. The planar angle shift aligns a viewing plane of the captured image facial characteristics for comparison with a comparative image by the security module for the facial recognition and/or the iris recognition. This adjusts the face of the user for a clearer angle of view, and substantially reduces the angular distortion so that the user face and the comparative image will appear parallel, or approximately parallel, to each other for comparison.

While features and concepts of the described techniques for foldable mobile device camera and face detection are implemented in any number of different devices, systems, environments, and/or configurations, implementations of the techniques for foldable mobile device camera and face detection are described in the context of the following example devices, systems, and methods.

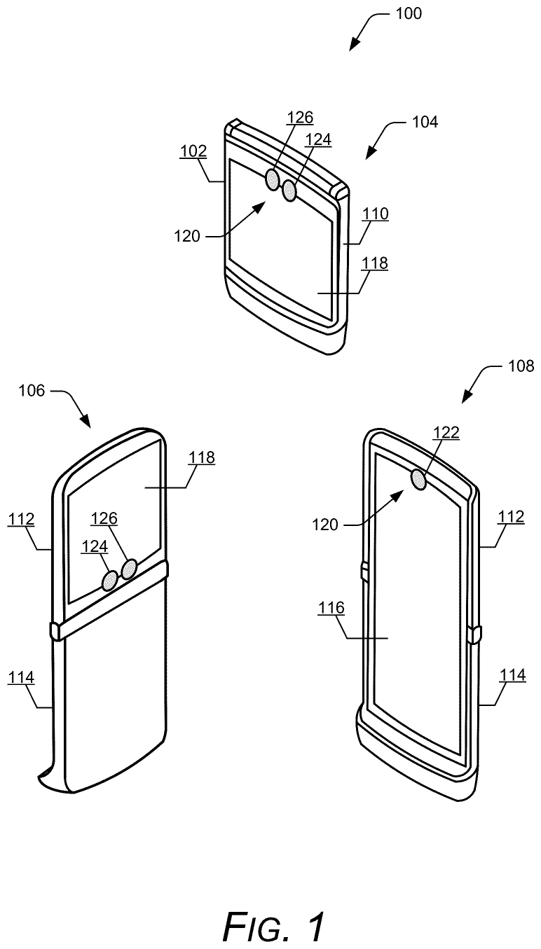

FIG. 1 illustrates an example 100 of a foldable mobile device 102 in implementations of a foldable mobile device camera, as described herein. Examples of a foldable mobile device or expandable mobile device may include any type of a wireless device, mobile device, mobile phone, flip phone, smartphone, client device, companion device, tablet, communication device, entertainment device, gaming device, media playback device, or any other type of computing, consumer, and/or electronic device. In this example 100, the foldable mobile device 102 is shown in a first view 104 in a folded form factor, and a back of the device is shown in a second view 106 in an opened form factor of the device. A front of the foldable mobile device 102 is also shown in a third view 108 in the opened form factor of the device.

In this example 100, the foldable mobile device 102 has a foldable housing 110, which is operational to fold the device from the opened form factor, as shown in the second view 106 and in the third view 108, to the folded form factor of the device, as shown in the first view 104. The foldable housing 110 of the foldable mobile device 102 includes a first half 112 of the foldable housing and a second half 114 of the foldable housing. Although housing components of the foldable housing 110 are indicated as the first half 112 and the second half 114 of the foldable housing, they may be only approximately or generally half of the foldable housing that overlap to form a smaller, convenient to carry device. Additionally, the first half 112 of the foldable housing 110 may also be referred to as the top half of the foldable mobile device 102, while the second half 114 of the foldable housing may also be referred to as the bottom half of the device, given the perspectives shown in the second view 106 and the third view 108 of the foldable mobile device.

In implementations, the foldable mobile device 102 may be a multi-screen device, having two or more display screens. In this example 100, the foldable mobile device 102 includes a relatively larger primary display screen 116, and a relatively smaller secondary display screen 118. The primary display screen 116 may also be referred to as the inner or interior display screen (or is a two-part display screen), which is folded between the first half 112 and the second half 114 of the foldable housing 110 in the folded form factor of the foldable mobile device. The secondary display screen 118 may also be referred to as the outer or exterior display screen, which remains viewable in both the folded form factor of the foldable mobile device, as shown in the first view 104 of the device, and in the opened form factor of the foldable mobile device, as shown in the second view 106 of the device.

In this example 100, the primary display screen 116 is located on one side (e.g., the front side) of the foldable mobile device 102, as shown in the third view 108, and the secondary display screen 118 is located on the opposite side (e.g., the back side) of the foldable mobile device, as shown in the second view 106. Generally, the primary display screen 116 and the secondary display screen 118 on the opposite sides of the foldable mobile device 102 may be the same size, approximately the same size, or vary in different sizes. In this example 100, the secondary display screen 118 is relatively smaller than the primary display screen 116 and may be utilized as a notification screen that displays any type of user interface or notifications associated with device applications on the foldable mobile device.

In implementations, the foldable mobile device 102 in this example 100 includes a camera system 120, which includes a front-facing camera 122, as shown in the third view 108 of the device. The camera system 120 also includes one or more rear-facing cameras, such as a main camera 124 and an ultrawide camera 126. In implementations, the rear-facing camera or cameras may be a single camera, a main camera and an ultrawide camera, a main camera and a telephoto camera, or may include multiple types of cameras, such as a main camera, an ultrawide camera, and a telephoto camera. Generally, a lens of the front-facing camera 122 is integrated in or around the primary display screen 116 of the foldable mobile device 102, and faces a user as he or she holds the device in a position to view the primary display screen. Users commonly use the front-facing camera 122 to take pictures (e.g., digital images) of themselves, such as self-portrait digital images often referred to as “selfies.” Similarly, lenses of the rear-facing cameras are integrated in the back of the foldable housing 110 of the foldable mobile device 102, or are integrated in or around the secondary display screen 118 of the device. In this example 100, and as shown in the second view 106, the rear-facing cameras face away from the user toward the surrounding environment (e.g., as seen from the point-of-view of the user). Users commonly use the rear-facing camera or cameras to capture digital images in front of them in the surrounding environment.

In aspects of the described foldable mobile device 102, a user of the device may utilize one or more of the rear-facing cameras (e.g., the main camera 124 and/or the ultrawide camera 126) to capture digital content. As used herein, the term digital content includes any type of digital image, facial image, digital photograph, a selfie, a digital video frame of a video clip, digital video, and any other type of digital content. For example, a user may use the main camera 124 and/or the ultrawide camera 126 to capture a facial image, such as for facial recognition and authentication to biometrically unlock and access the device. Although generally described in the context of facial recognition, aspects of the techniques described herein may be equally applicable and implemented for iris recognition. As similarly described, for example, a user may use the main camera 124 and/or the ultrawide camera 126 to capture a facial image, such as for iris recognition and authentication to biometrically unlock and access the device. In implementations, the main camera 124 and/or the ultrawide camera 126 are located to face a user of the foldable mobile device 102 as he or she holds the device in a position to view the secondary display screen 118 in the folded form factor of the device.

In aspects of the described techniques, the main camera 124 and/or the ultrawide camera 126 are located approximately centered between the first half 112 of the foldable housing 110 and the second half 114 of the foldable housing in the opened form factor of the foldable mobile device 102, such as shown in the second view 106. Accordingly, the main camera 124 and/or the ultrawide camera 126 are located at a top edge of the first half 112 of the foldable housing 110 when the device is folded into the folded form factor, as shown in the first view 104. In implementations, one or more of the main camera 124 or the ultrawide camera 126 can be located in approximately the center (as shown in the first view 104), or to the left of center, or to the right of center along the top edge of the first half 112 of the foldable housing 110 in the folded form factor of the foldable mobile device. Notably, a camera device (e.g., the main camera 124 and/or the ultrawide camera 126) located at the top edge of the first half 112 of the foldable housing 110 in the folded form factor of the foldable mobile device has a region-of-view conducive to capturing a facial image with facial characteristics that are usable for facial recognition.

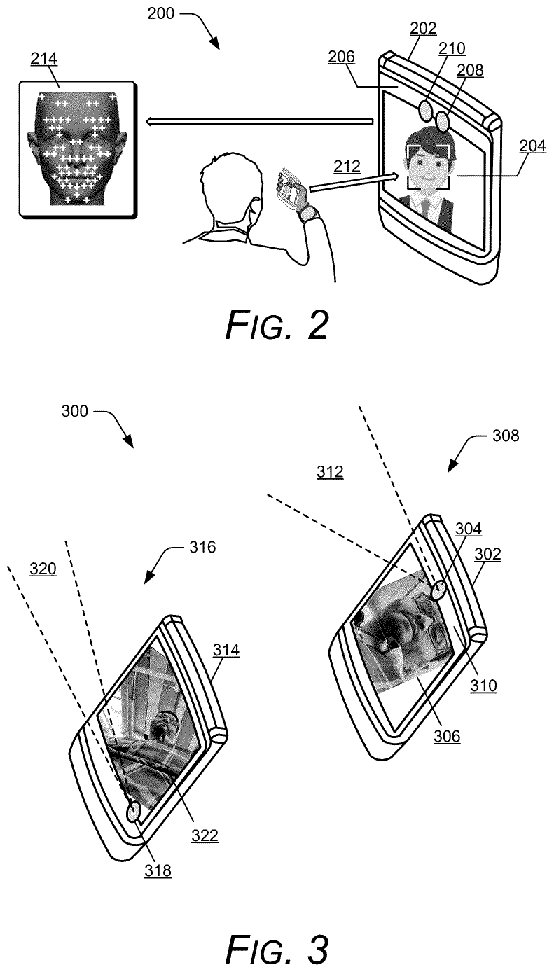

FIG. 2 illustrates an example 200 of a captured facial image for facial recognition for foldable mobile device camera and face detection, as described herein. In this example 200, a foldable mobile device 202 is used to capture a facial image 204 in a folded form factor of the device. The foldable mobile device 202 is an example of the foldable mobile device 102 as shown and described with reference to FIG. 1. For example, the foldable mobile device 202 includes one or more camera devices located at a top edge 206 of a half of the foldable housing when the device is folded into the folded form factor, such as a main camera 208 and an ultrawide camera 210. The camera or cameras can be utilized by a user of the device to perform facial recognition for device authentication and access. As similarly described with reference to the foldable mobile device 102 (FIG. 1), the main camera 208 and/or the ultrawide camera 210 of the foldable mobile device 202 are located to face a user of the device as he or she holds the device in a position to view the secondary display screen in the folded form factor of the device. In implementations, a user can initiate facial recognition to access a mobile device that has an integrated camera with a closed lid interface (CLI) camera sensor and facial unlock feature.

Facial recognition is a technology used to detect a human face and compare the face as captured in a digital image or a video frame against a database of faces. Generally, a facial image captured on an approximate horizontal plane 212 relative to the user (e.g., the camera is straight-on to the face of the user) is more likely to have facial characteristics that align with a stored, comparative image 214, and is more likely to result in a successful facial recognition for authentication to biometrically unlock and access the device. Facial recognition pinpoints and measures facial features in a given image, and then can be used to authenticate a user based on biometric identification verification.

There are typically two types of solutions for facial recognition and authentication, and may depend on hardware implementations. A face two-dimensional (2D) solution typically utilizes an RGB camera (without any other sensors). A face three-dimensional (3D) solution typically utilizes 3D sensors, such as infra-red (IR) sensors and/or time-of-flight (ToF) sensors that rely on emitted light and bounce back from an object (e.g., a face) to create a detailed 3D image. While the face 3D solution is more accurate, it is expensive to implement, such as in a mobile phone device. The face 2D solution is less expensive to implement, given that most mobile devices already incorporate a camera device, yet may not be as reliable for security, face authentication, unlocking a device, and/or for payment transaction authorizations due to having a high spoof acceptance rate (SAR) value (which is a measure of how often a spoofed biometric sample is accepted as legitimate).

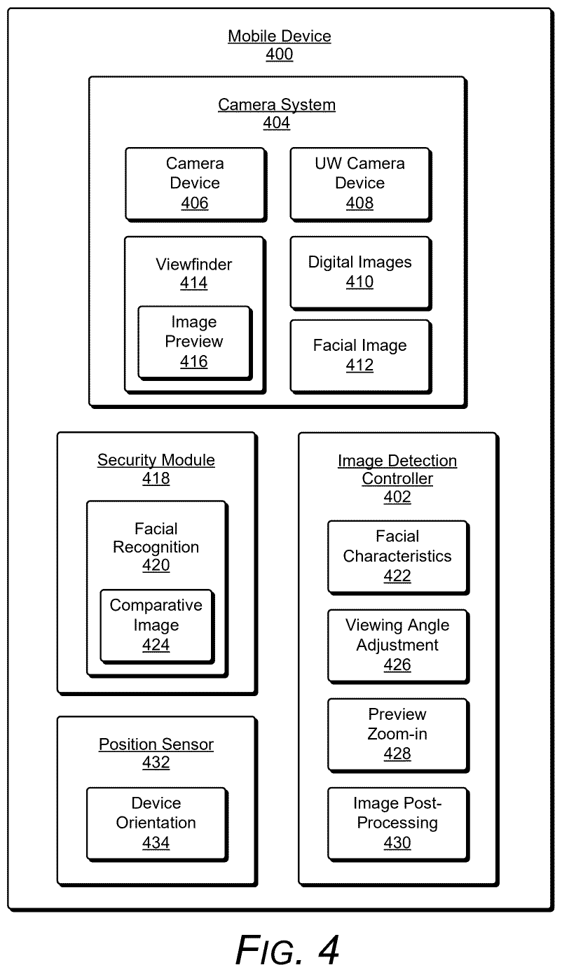

FIG. 3 further illustrates an example 300 of a mobile device for foldable mobile device camera and face detection, as described herein. In this example 300, a foldable mobile device 302 includes a camera device 304 used to capture a facial image 306 in a folded form factor of the device, as shown at 308. The foldable mobile device 302 is an example of the foldable mobile device 102 as shown and described with reference to FIG. 1. For example, the foldable mobile device 302 includes the camera device 304 located at a top edge 310 of a half of the foldable housing when the device is folded into the folded form factor. The camera device 304 can be utilized by a user of the device to perform facial recognition for device authentication and access. As similarly described with reference to the foldable mobile device 102 (FIG. 1), the camera device 304 of the foldable mobile device 302 is located to face a user of the device as he or she holds the device in a position to view the secondary display screen in the folded form factor of the device.

In aspects of the described techniques, the camera device 304 that is approximately centered and located at the top edge 310 of the device (and facing the user) provides a relatively wider region-of-view 312 for the camera to capture the facial image 306 of the user for facial recognition and authentication. In contrast, a typical foldable mobile device 314 is shown at 316 having a camera device 318 positioned at a typical lower corner location. Given the position of the camera device 318 near the bottom edge of the display and/or housing, the rear-facing camera (in the folded form factor of the device) has only a narrow region-of-view 320. This can be problematic if a user is holding the device down at a lower angle, such as if the user takes the device out of his or her pocket and glances down to unlock the device using facial recognition.

Given the relatively narrow region-of-view 320, and the upward angle at which a facial image 322 is captured with the foldable mobile device 314 in the closed lid interface (CLI) state, the facial image 322 may not be adequate for facial recognition use to authenticate the user and unlock the device, resulting in authentication failure. As shown in this example, the facial image 322 is a vertical image viewing upward at the bottom of the face of the user, which will likely result in a false rejection of the user due to the facial characteristics cannot be determined and matched to a comparative image for authentication. This leads to a poor user experience, as well as precludes the benefit of a seamless user experience.

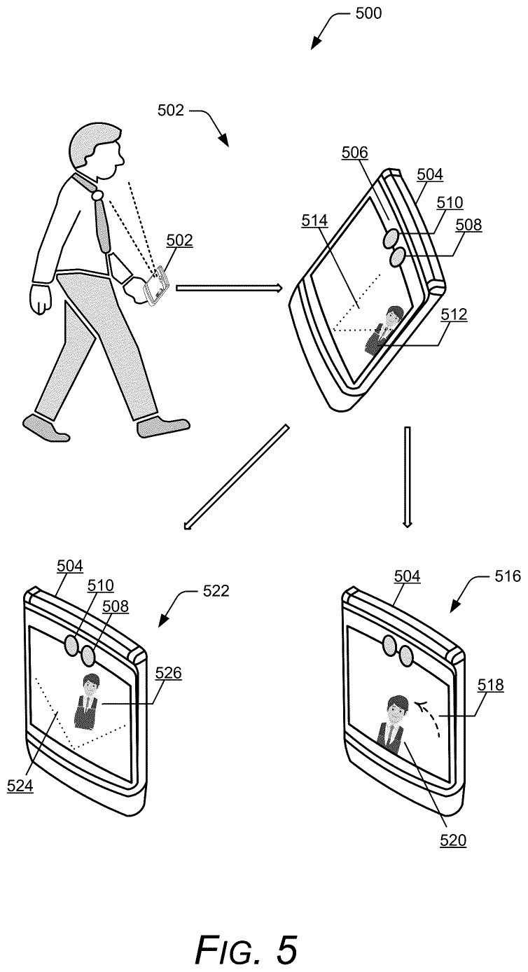

FIG. 4 illustrates an example of a mobile device 400 for foldable mobile device camera and face detection, as described herein. In aspects of the described techniques, the mobile device 400 may include any type of foldable and/or expandable device configured to perform aspects of the techniques as described herein. Examples of the mobile device 400 include the foldable mobile device 102, the foldable mobile device 202, and/or the foldable mobile device 302. Additionally, or alternatively, the mobile device 400 may be any type of a mobile device, wireless device, media device, mobile phone, flip phone, client device, tablet, computing, communication, entertainment, gaming, media playback, and/or any other type of computing, consumer, and/or electronic device may be configured to perform aspects of the techniques for foldable mobile device camera and face detection, as described herein. Although generally described in the context of a foldable mobile device, aspects of the described techniques may be implemented with any type of a non-folding mobile device as well.

The mobile device 400 can be implemented with various components, such as a processor system and memory, as well as any number and combination of different components as further described with reference to the example device shown in FIG. 12. In implementations, the mobile device 400 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices includes at least one of a WiFi radio, a cellular radio, a global positioning satellite (GPS) radio, or any available type of device communication interface.

In some implementations, the devices, applications, modules, servers, and/or services described herein communicate via a communication network, such as for data communication with the mobile device 400. The communication network can include a wired and/or a wireless network. The communication network may be implemented using any type of network topology and/or communication protocol, and can be represented or otherwise implemented as a combination of two or more networks, to include IP-based networks, cellular networks, and/or the Internet. A communication network may include mobile operator networks that are managed by a mobile network operator and/or other network operators, such as a communication service provider, mobile phone provider, and/or Internet service provider.

The mobile device 400 includes various functionality that enables the device to implement different aspects of foldable mobile device camera and face detection, as described herein. In one or more implementations, the mobile device 400 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 400. Generally, an application user interface, or any other type of video, image, graphic, and the like is digital image content that is displayable on the display screen of the mobile device 400.

In this example, the mobile device 400 implements an image detection controller 402 (e.g., as a device application). As shown in this example, the image detection controller 402 represents functionality (e.g., logic, software, and/or hardware) enabling aspects of the described techniques for foldable mobile device camera and face detection. The image detection controller 402 can be implemented as computer instructions stored on computer-readable storage media and can be executed by a processor system of the mobile device 400. Alternatively, or in addition, the image detection controller 402 can be implemented at least partially in hardware of the device.

In one or more implementations, the image detection controller 402 includes independent processing, memory, and/or logic components functioning as a computing and/or electronic device integrated with the mobile device 400. Alternatively, or in addition, the image detection controller 402 can be implemented in software, in hardware, or as a combination of software and hardware components. In this example, the image detection controller 402 is implemented as a software application or module, such as executable software instructions (e.g., computer-executable instructions) that are executable with a processor system of the mobile device 400 to implement the techniques and features described herein. As a software application or module, the image detection controller 402 can be stored on computer-readable storage memory (e.g., memory of a device), or in any other suitable memory device or electronic data storage implemented with the controller. Alternatively or in addition, the image detection controller 402 is implemented in firmware and/or at least partially in computer hardware. For example, at least part of the image detection controller 402 is executable by a computer processor, and/or at least part of the image detection controller is implemented in logic circuitry.

The mobile device 400 has a camera system 404, which includes one or more camera devices. For example, the camera system 404 includes a main camera device 406 and an ultrawide camera device 408. In implementations, the camera system 404 may include a rear-facing camera or cameras, a front-facing camera or cameras, a single camera, a main camera and an ultrawide camera, a main camera and a telephoto camera, or may include multiple types of cameras, such as a main camera, an ultrawide camera, and a telephoto camera. The camera system 404 (e.g., the main camera device 406 and/or the ultrawide camera device 408) capture digital content, which may include any type of digital images 410, a facial image 412, digital photograph, a selfie, a digital video frame of a video clip, digital video, and any other type of digital content. For example, a user of the mobile device 400 may use the main camera device 406 and/or the ultrawide camera device 408 to capture a facial image, such as for facial recognition and authentication to biometrically unlock and access the device. The mobile device 400 also includes a security module 418 that facilitates facial recognition 420 and authentication. In implementations, the security module 418 provides that the facial recognition 420 is a class 3 biometric with a security level for unlocking the mobile device 400 and/or accessing a secure application, such as a digital credit card or other digital payment method on the mobile device.

In this example, the camera system 404 of the mobile device 400 includes a viewfinder 414 that displays image previews, such as an image preview 416 of a digital image 410 or an image preview of a facial image 412. In implementations, an image preview 416 of a digital image or facial image is displayed on a display screen of the mobile device 400, before a user initiates to capture the digital image or the facial image. In a mobile phone device, for example, the viewfinder 414 may be implemented as a software and/or hardware component of the display screen of the mobile phone device.

In one or more implementations, a user of the mobile device 400 may initiate to access the device based on facial recognition 420 and authentication provided by the security module 418. For example, the user of the mobile device 400 can use the main camera device 406 to capture a facial image 412, or an image preview 416 of the facial image. In aspects of the described techniques, the image detection controller 402 receives or obtains the image preview 416 of the facial image 412, and the image detection controller 402 detects that facial characteristics 422 in the image preview 416 of the facial image 412 will not support facial recognition 420 by the security module 418.

For example, a user of the mobile device 400 may hold the device down at a lower angle, such as if the user takes the device out of his or her pocket and glances down to unlock the device using facial recognition. Given the upward angle at which the facial image 412 is captured, the facial image is a vertical image viewing upward at the bottom of the face of the user, which may not be adequate for facial recognition 420 to authenticate the user and unlock the device. This authentication failure is likely due to the facial characteristics 422 cannot be determined and matched to a comparative image 424 for authentication, which leads to a poor user experience, as well as precludes the benefit of a seamless user experience.

In aspects of this disclosure, the image detection controller 402 can apply one or more techniques to revise an image preview 416 of a facial image 412 so that the facial characteristics 422 will support facial recognition 420 by the security module 418. In implementations, the image detection controller 402 can apply a viewing angle adjustment 426, apply a preview zoom-in 428, and/or apply image post-processing 430. In implementations, the image detection controller 402 can apply the image post-processing based on an orientation of the mobile device and/or camera device, as detected by a position sensor 432.

In this example, the mobile device 400 includes the position sensor 432 that detects device orientation 434 of the mobile device 400 and/or a camera device 406. For example, the position sensor 432 may be a gravity sensor, or other type of sensor or a combination of sensors (e.g., a gyro and accelerometer), that detect device alignment with Earth horizontal. In described aspects, the image post-processing 430 is a planar angle shift to align, or approximately align, the viewing plane of a captured facial image for parallel comparison with the comparative image 424 by the security module 418 for the facial recognition 420. In this example, the image detection controller 402 can adjust the viewing angle digitally by applying the image post-processing 430, to a better viewing angle (or relative X, Y coordinates and correct an X, Y plane shift). This can be implemented in the mobile device 400 as sequentially sampling and comparing a current image preview frame to a captured post frame. Once an ideal or satisfactory angle (or central image coordinates X′, Y′) has been attained, the digital orientation of the camera device 406 can be paused, shifting to a monitoring mode.

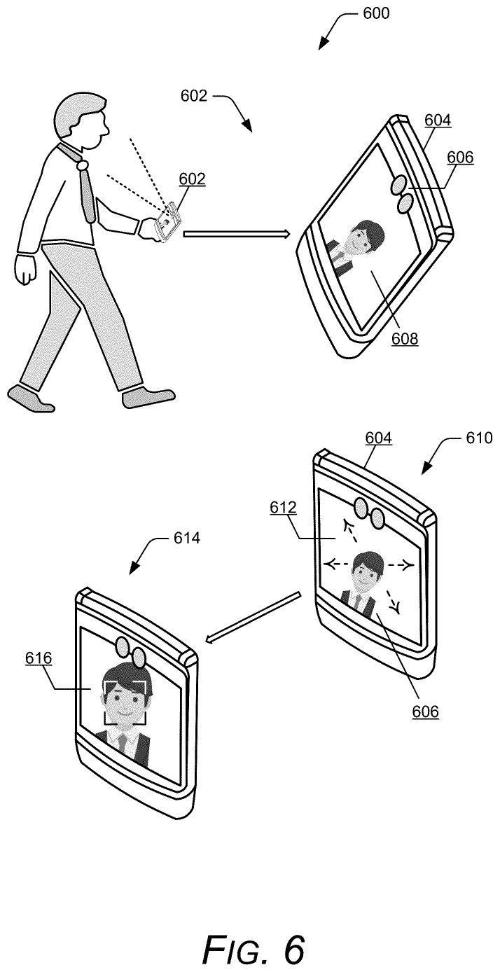

In further aspects of this disclosure, as shown and described with reference to FIG. 5, the image detection controller 402 can detect that an image preview 416 of a facial image 412 may be misaligned in a region-of-view of the main camera device 406, which will likely result in unsuccessful facial recognition 420 by the security module 418. The image detection controller 402 can apply a viewing angle adjustment 426 to adjust a viewing angle of the viewfinder 414 so that the facial image 412 is realigned in the viewfinder, which increases detectability of the facial characteristics 422 for the facial recognition. Additionally, or alternatively, the image detection controller 402 can detect that the facial characteristics 422 in the image preview 416 of the facial image 412 are too small for successful facial recognition 420 by the security module 418. The secondary, ultrawide camera device 408 can then be used to capture an updated image preview 416 of a facial image 412. With the wider field-of-view of the ultrawide camera device 408, the facial image 412 is better aligned in the viewfinder 414 so that the facial characteristics 422 are detectable in the updated image preview of the facial image.

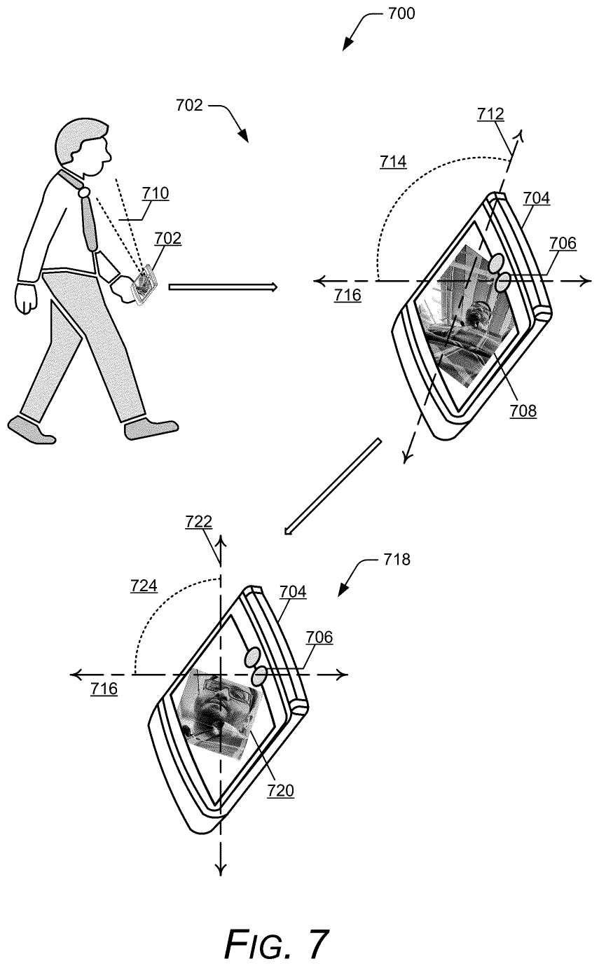

In further aspects of this disclosure, as shown and described with reference to FIG. 6, the image detection controller 402 can detect that the facial characteristics 422 in an image preview 416 of facial image 412 are too small for the facial recognition, which will likely result in unsuccessful facial recognition 420 by the security module 418. The image detection controller 402 can apply the preview zoom-in 428 of the facial image 412, and the zoomed-in image preview increases detectability of the facial characteristics 422 for the facial recognition. In further aspects, the image detection controller 402 can detect that the facial characteristics 422 in the image preview 416 of a facial image 412 are too small for successful facial recognition 420 by the security module 418. The secondary, ultrawide camera device 408 can then be used to capture an updated image preview 416 of a facial image 412. However, the updated image preview captured with the ultrawide camera device 408 may still be detected by the image detection controller 402 as being too small for successful facial recognition 420 by the security module 418. Accordingly, the image detection controller 402 applies the preview zoom-in 428 for the updated image preview of the facial image so that the facial characteristics 422 are detectable in the updated image preview of the facial image.

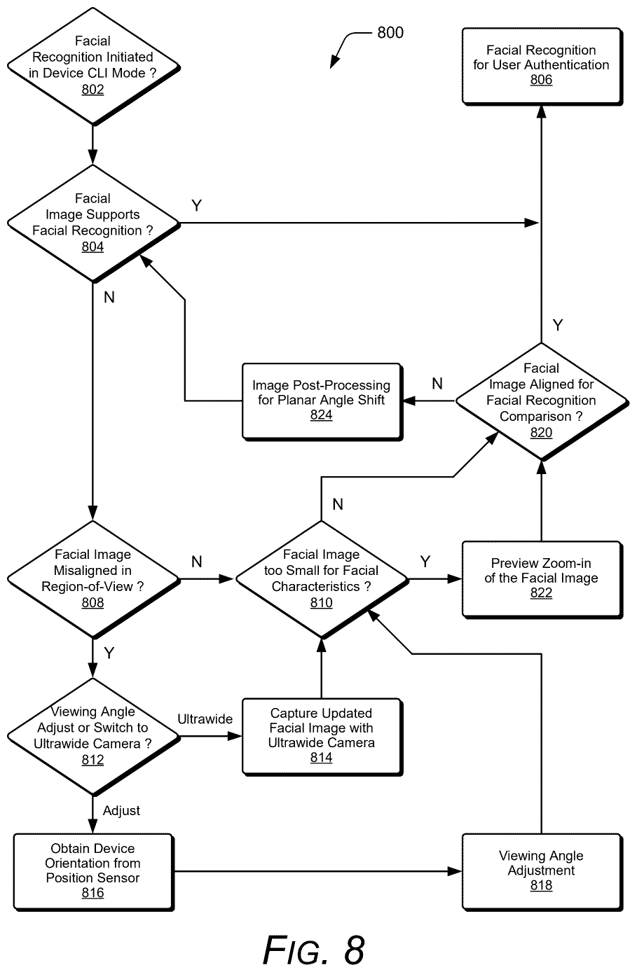

In further aspects of this disclosure, as shown and described with reference to FIG. 7, the image detection controller 402 can detect that facial characteristics 422 of the face of a user in a captured facial image 412 will not support facial recognition (e.g., due to a vertical angle of the image). Additionally, the image detection controller 402 can obtain or receive an indication of the orientation 434 of the mobile device 400 and/or the orientation 434 of the main camera device 406 when the facial image 412 is captured, as detected by the position sensor 432. The alignment of the facial image 412 and the orientation 434 of the device can be detected diagonally, horizontally, or vertically. In implementations, the image detection controller 402 applies the image post-processing 430, such as based on the orientation of the mobile device 400 and/or the camera device 406, as detected by the position sensor 432, to increase detectability of the facial characteristics 422 for the facial recognition. The image detection controller 402 can apply the image post-processing 430 to generate an updated facial image 412 based on a planar angle shift to increase detectability of the facial characteristics for the facial recognition. The planar angle shifts align a viewing plane for captured image facial characteristics for comparison with the comparative image 424 by the security module 418 for the facial recognition 420. This adjusts the user face for a clearer angle of view, and substantially reduces the angular distortion so that the user face and the comparative image will appear parallel, or approximately parallel, to each other for comparison.

Notably, aspects of the described techniques can be applied individually and/or in any combination to increase detectability of the facial characteristics for successful facial recognition. In implementations, the image detection controller 402 can apply any one or more of the viewing angle adjustment 426, the preview zoom-in 428, and/or the image post-processing 430 to revise an image preview 416 of a facial image 412, or to revise a captured facial image 412, so that the facial characteristics 422 will support facial recognition 420 by the security module 418.

For example, the image detection controller 402 can detect that the facial characteristics 422 in the image preview 416 of a facial image 412 are too small for the facial recognition 420, and apply the preview zoom-in 428 for the facial image 412 to increase detectability of the facial characteristics 422 for the facial recognition 420. Similarly, the image detection controller 402 can detect that the facial characteristics in the preview of the facial image are too small for the facial recognition, and apply the preview zoom-in 428 for the facial image 412. The image detection controller 402 can then apply the image post-processing 430 for an orientation of the zoomed-in preview of the facial image 412 based on a planar angle shift to increase detectability of the facial characteristics 422 for the facial recognition 420. Similarly, the image detection controller 402 can detect that the facial characteristics 422 in the image preview 416 of the facial image 412 are too small for the facial recognition 420. The image detection controller 402 can then initiate to capture an updated preview of the facial image 412 with the secondary camera device (e.g., the ultrawide camera device 408 with the wider field-of-view) so that the facial characteristics 422 are detectable in the updated image preview 416 of the facial image 412 and support the facial recognition 420 by the security module 418.

In additional examples, the image detection controller 402 can detect that a face in the image preview 416 of the facial image 412 is misaligned in a region-of-view of the main camera device 406. The image detection controller 402 can then initiate to capture an updated image preview 416 of the facial image 412 with the secondary, ultrawide camera device 408 with the wider field-of-view, so that the facial characteristics 422 are detectable in the updated image preview 416 of the facial image 412 and support the facial recognition 420 by the security module 418. Similarly, the image detection controller 402 can detect that a face in the image preview 416 of the facial image 412 is misaligned in a region-of-view of the main camera device 406, and initiate to capture an updated image preview 416 of the facial image 412 with the secondary, ultrawide camera device 408 with the wider field-of-view. The image detection controller 402 can then apply the preview zoom-in 428 for the updated image preview 416 of the facial image 412 to increase detectability of the facial characteristics 422 for the facial recognition 420. Similarly, the image detection controller 402 can detect that a face in the image preview 416 of the facial image 412 is misaligned in a region-of-view of the main camera device 406, initiate to capture an updated image preview 416 of the facial image 412 with the secondary, ultrawide camera device 408 with the wider field-of-view, and apply the preview zoom-in 428 for the updated image preview 416 of the facial image 412. The image detection controller 402 can then apply the image post-processing 430 to post-process an orientation 434 of the zoomed-in updated image preview 416 of the facial image 412 based on a planar angle shift to increase detectability of the facial characteristics 422 for the facial recognition 420.

In additional examples, the image detection controller 402 can detect that the facial characteristics 422 in an image preview 416 of a facial image 412 will not support the facial recognition 420 by the security module 418. The image detection controller 402 can then initiate to revise, based on a detected orientation 434 of the mobile device 400, the image preview 416 of the facial image 412 so that the facial characteristics 422 will support the facial recognition. For example, the image detection controller 402 can detect that a face in the image preview 416 of the facial image 412 is misaligned in a region-of-view of the main camera device 406, and adjust a viewing angle of the viewfinder 414 according to the detected orientation 434 of the mobile device. In implementations, the position sensor 432 detects the device orientation 434 of the mobile device 400 and/or the device orientation 434 of a camera device relative to horizontal. The image detection controller 402 can then adjust a viewing angle of the viewfinder 414 to approximately correlate with the detected orientation of the mobile device and/or the camera device.

In additional examples, the image detection controller 402 can detect that a face in the image preview 416 of the facial image 412 is misaligned in a region-of-view of the camera device 406, and adjust a viewing angle of the viewfinder 414 to decrease or eliminate angular distortion of the face in the image preview of the facial image. In implementations, the image detection controller 402 can apply the image post-processing 430 to post-process the image preview 416 of the facial image 412 based on a planar angle shift to increase detectability of the facial characteristics 422 for the facial recognition 420 performed by the security module 418. Similarly, the image detection controller 402 can detect a vertical image of a face in the image preview 416 of a facial image 412, and apply the viewing angle adjustment 426 for the viewfinder 414 to decrease or eliminate a vertical angle of the vertical image of the face in the image preview of the facial image. In other implementations, the image detection controller 402 applies the image post-processing 430 to post-process the image preview 416 of the facial image 412 based on a planar angle shift to increase detectability of the facial characteristics 422 for the facial recognition 420. Similarly, the image detection controller 402 applies the viewing angle adjustment 426 to adjust a viewing angle of the viewfinder 414 to align the facial characteristics 422 in the image preview 416 of the facial image 412 with the facial characteristics in the comparative image 424 for the facial recognition 420 by the security module 418.

FIG. 5 illustrates examples 500 of revising an image preview for foldable mobile device camera and face detection, as described herein. As shown at 502, a foldable mobile device 504 includes a camera system 506 with camera devices, such as a main camera device 508 and an ultrawide camera device 510. The main camera device 508 may be used to capture a facial image 512 in a folded form factor of the device. The foldable mobile device 504 is an example of the foldable mobile device 102 as shown and described with reference to FIG. 1. Additionally, the foldable mobile device 504 can be implemented as the mobile device 400 shown and described with reference to FIG. 4 configured to perform aspects of the techniques for foldable mobile device camera and face detection, as described herein. For example, the foldable mobile device 504 includes the main camera device 508 and the ultrawide camera device 510 located at a top edge of a half of the foldable housing when the device is folded into the folded form factor. The main camera device 508 can be utilized by a user of the device to perform facial recognition for device authentication and access. As similarly described with reference to the foldable mobile device 102 (FIG. 1), the camera devices of the foldable mobile device 504 are located to face a user of the device as he or she holds the device in a position to view the secondary or outer display screen in the folded form factor of the device.

In the example shown at 502, the preview of the facial image 512 is misaligned in a region-of-view 514 of the main camera device 508. In an implementation of the foldable mobile device 504 (e.g., as the mobile device 400), the image detection controller 402 detects that the face of the user in the preview of the facial image 512 is misaligned in the region-of-view 514 of the camera device, which will likely result in unsuccessful facial recognition 420 by the security module 418. In implementations, and as shown at 516, the image detection controller 402 adjusts a viewing angle 518 of the viewfinder 414 (e.g., a viewing angle adjustment 426) to realign the facial image 520 in the viewfinder and increase detectability of the facial characteristics 422 for the facial recognition.

In another implementation, and as shown at 522, the image detection controller 402 detects that the face of the user in the preview of the facial image 512 is misaligned in the region-of-view 514 of the main camera device 508. Additionally, or alternatively, the image detection controller 402 detects that the facial characteristics 422 in the preview of the facial image 512 are too small for successful facial recognition 420 by the security module 418. The secondary, ultrawide camera device 510 can then be used to capture an updated image preview 416 of a facial image 526, where the ultrawide camera device 510 has a wider field-of-view 524 and the facial image 526 is better aligned in the viewfinder so that the facial characteristics 422 are detectable in the updated image preview of the facial image.

FIG. 6 illustrates an example 600 of revising an image preview for foldable mobile device camera and face detection, as described herein. As shown at 602, a foldable mobile device 604 includes a camera system 606 with camera devices, such as a main camera device and an ultrawide camera device. A camera device of the camera system may be used to capture a facial image 608 in a folded form factor of the device. The foldable mobile device 604 is an example of the foldable mobile device 102 as shown and described with reference to FIG. 1. Additionally, the foldable mobile device 604 can be implemented as the mobile device 400 shown and described with reference to FIG. 4 configured to perform aspects of the techniques for foldable mobile device camera and face detection, as described herein. For example, the camera devices (e.g., a main camera device) can be utilized by a user of the device to perform facial recognition for device authentication and access. As similarly described with reference to the foldable mobile device 102 (FIG. 1), the camera devices of the foldable mobile device 604 are located to face a user of the device as he or she holds the device in a position to view the secondary or outer display screen in the folded form factor of the device.

In the example shown at 602, the preview of the facial image 608 may be too small, and in an implementation of the foldable mobile device 604 (e.g., as the mobile device 400), the image detection controller 402 detects that the facial characteristics 422 in the preview of the facial image 608 are too small for the facial recognition, which will likely result in unsuccessful facial recognition 420 by the security module 418. In implementations, and as shown at 610, the image detection controller 402 zooms-in 612 (e.g., applies preview zoom-in 428) the facial image 608. As then shown at 614, the zoomed-in image preview 616 increases detectability of the facial characteristics 422 for the facial recognition.

In other implementations, the image detection controller 402 detects that the facial characteristics 422 in the preview of the facial image 608 are too small for successful facial recognition 420 by the security module 418. The secondary, ultrawide camera device can then be used to capture an updated image preview 416 of a facial image, where the ultrawide camera device has a wider field-of-view. However, the updated image preview captured with the ultrawide camera device may still be detected by the image detection controller 402 as being too small for successful facial recognition 420 by the security module 418. Accordingly, the image detection controller 402 applies preview zoom-in 428 for the updated image preview of the facial image so that the facial characteristics 422 are detectable in the updated image preview of the facial image.

FIG. 7 illustrates an example 700 of revising an image preview for foldable mobile device camera and face detection, as described herein. As shown at 702, a foldable mobile device 704 includes a camera system with one or more cameras, such as a main camera device 706. The main camera device 706 may be used to capture a facial image 708 in a folded form factor of the device. The foldable mobile device 704 is an example of the foldable mobile device 102 as shown and described with reference to FIG. 1. Additionally, the foldable mobile device 504 can be implemented as the mobile device 400 shown and described with reference to FIG. 4 configured to perform aspects of the techniques for foldable mobile device camera and face detection, as described herein. For example, the foldable mobile device 704 includes the camera system (e.g., the main camera device 706 and an ultrawide camera device) located at a top edge of a half of the foldable housing when the device is folded into the folded form factor. The main camera device 706 can be utilized by a user of the device to perform facial recognition for device authentication and access. As similarly described with reference to the foldable mobile device 102 (FIG. 1), the camera devices of the foldable mobile device 704 are located to face a user of the device as he or she holds the device in a position to view the secondary or outer display screen in the folded form factor of the device.

In the example shown at 702, the user is holding the device down at a lower angle, such as if the user takes the device out of his or her pocket and glances down to unlock the device using facial recognition. Given the relatively narrow region-of-view 710, and the upward angle at which the image preview of the facial image 708 is captured with the foldable mobile device 314 in the closed lid interface (CLI) state, the captured facial image 708 may not be adequate for facial recognition use to authenticate the user and unlock the device, resulting in authentication failure. As shown in this example, the captured facial image 708 is a vertical image viewing upward at the bottom of the face of the user, which will likely result in a false rejection of the user due to the facial characteristics cannot be determined and matched to a comparative image for authentication.

Accordingly, in implementations of the foldable mobile device 704 (e.g., as the mobile device 400), the image detection controller 402 detects that facial characteristics 422 of the face of the user in the captured facial image 708 will not support facial recognition (e.g., due to the vertical angle of the image). Additionally, the image detection controller 402 can obtain or receive an indication of the orientation of the foldable mobile device 704 and/or the main camera device 706 when the facial image 708 is captured, as detected by the position sensor 432. For example, an orientation 712 of the foldable mobile device 704 and/or the main camera device 706 (and the captured facial image 708) is angled at a detectable angle 714 relative to horizontal 716. In implementations, the angles (e.g., the detectable angle 714) can be detected diagonally, horizontally, or vertically, depending on the aspect of the captured facial image being considered.

In implementations, the image detection controller 402 applies the image post-processing 430, such as based on the orientation of the foldable mobile device 704 and/or the camera device 706, as detected by the position sensor 432, to increase detectability of the facial characteristics 422 for the facial recognition. As shown at 718, the image detection controller 402 applies the image post-processing 430 to generate an updated facial image 720 based on a planar angle shift to increase detectability of the facial characteristics for the facial recognition. For example, an orientation 722 of the updated facial image 720 is shifted to an angle 724 relative to horizontal 716. In implementations, the planar angle shifts align a viewing plane for captured image facial characteristics for comparison with a comparative image 424 by the security module 418 for the facial recognition 420. This adjusts the user face for a clearer angle of view, and substantially reduces the angular distortion so that the user face and the comparative image will appear parallel to each other for comparison.

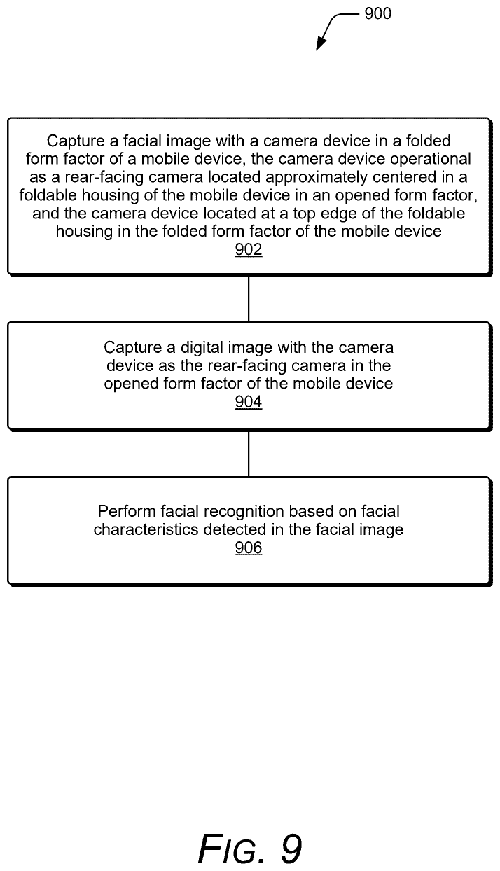

FIG. 8 illustrates an example process flow 800 for revising an image preview for foldable mobile device camera and face detection, as described herein. At 802, a determination is made that facial recognition 420 is initiated in a device CLI mode. In implementations, a user can initiate the facial recognition 420 to access the mobile device 400, which has the integrated camera device 406 with a closed lid interface (CLI) camera sensor and facial unlock feature.

At 804, a determination is made as to whether a facial image 412 supports the facial recognition 420. If the facial characteristics 422 of the facial image 412 support (e.g., are determined adequate) for the facial recognition 420 (i.e., “Yes” (Y) from 804), then at 806, the facial recognition 420 is performed for user authentication by the security module 418. Alternatively, if the facial characteristics 422 of the facial image 412 are determined insufficient to support the facial recognition 420 (i.e., “No” (N) from 804), then at 808, a determination is made as to whether the facial image 412 is misaligned in a region-of-view of a camera device 406 (e.g., the main camera).

If the facial image 412 is not misaligned in the region-of-view of the camera device 406 (i.e., “N” from 808), then at 810, a determination is made as to whether the facial image 412 is too small for detection of the facial characteristics 422 (for the facial recognition). If the facial image 412 is misaligned in the region-of-view of the camera device 406 (i.e., “Y” from 808), then at 812, a determination is made to apply a viewing angle adjustment 426, or switch to an ultrawide camera. If the determination is made to switch to the ultrawide camera device 408, then at 814, an updated facial image 412 is captured with the ultrawide camera device 408, and the process continues at 810. If the determination is made to apply the viewing angle adjustment 426, then at 816, the device orientation 434 is obtained from the position sensor 432, and at 818, the viewing angle adjustment 426 is applied to decrease or eliminate angular distortion of the face in the image preview 416 of the facial image 412. The process then continues at 810.

If the facial image 412 is not too small for detection of the facial characteristics 422 (for the facial recognition) (i.e., “N” from 810), then at 820, a determination is made as to whether the facial image 412 is aligned for facial recognition comparison with a comparative image 424 by the security module 418. However, if the facial image 412 is too small for detection of the facial characteristics 422 (for the facial recognition) (i.e., “Y” from 810), then at 822, the preview zoom-in 428 is applied to the image preview 416 of the facial image 412, and the process continues at 820.

If the facial image 412 is aligned for facial recognition comparison (i.e., “Y” from 820), then at 806, the facial recognition 420 is performed for user authentication by the security module 418. However, if the facial image 412 is not aligned for facial recognition comparison (i.e., “N” from 820), then at 824, the image post-processing 430 is applied to post-process the image preview 416 of the facial image 412 based on a planar angle shift to increase detectability of the facial characteristics 422 for the facial recognition 420. The process then continues at 804 to determine whether the revised and/or post-processed facial image supports the facial recognition 420 by the security module 418.

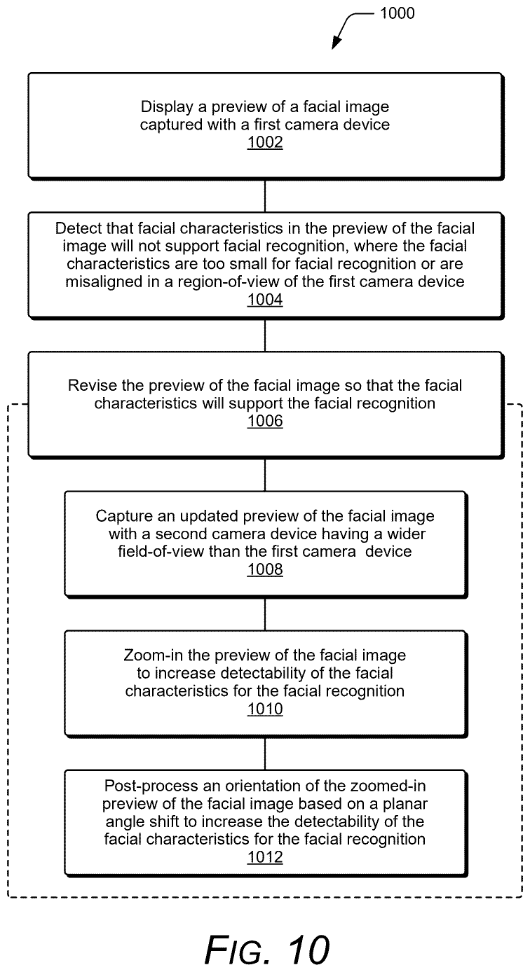

Example methods 900, 1000, and 1100 are described with reference to respective FIGS. 9, 10, and 11 in accordance with one or more implementations of foldable mobile device camera and face detection, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 9 illustrates example method(s) 900 for foldable mobile device camera. The order in which the method is described is not intended to be construed as a limitation, and any number or combination of the described method operations may be performed in any order to perform a method, or an alternate method.

At 902, a facial image is captured with a camera device in a folded form factor of a mobile device, the camera device operational as a rear-facing camera located approximately centered in a foldable housing of the mobile device in an opened form factor, and the camera device located at a top edge of the foldable housing in the folded form factor of the mobile device. For example, the foldable mobile device 102 includes one or more rear-facing cameras, such as the main camera 124, which can be used to capture a facial image, such as for facial recognition and authentication to biometrically unlock and access the device. The main camera 124 and/or the ultrawide camera 126 are located at a top edge of the first half 112 of the foldable housing 110 when the device is folded into the folded form factor. The main camera 124 located at the top edge of the foldable housing in the folded form factor of the mobile device 102 has a region-of-view conducive to capturing a facial image with the facial characteristics that are usable for the facial recognition.

At 904, a digital image is captured with the camera device as the rear-facing camera in the opened form factor of the mobile device. For example, the foldable mobile device 102 includes the main camera 124 and the ultrawide camera 126 as rear-facing cameras that face away from a user of the device toward the surrounding environment (e.g., as seen from the point-of-view of the user). Users commonly use the rear-facing camera or cameras to capture digital images in front of them in the surrounding environment. At 906, facial recognition is performed based on facial characteristics detected in the facial image. For example, the foldable mobile device 102 performs facial recognition based on the facial characteristics detected in the facial image.

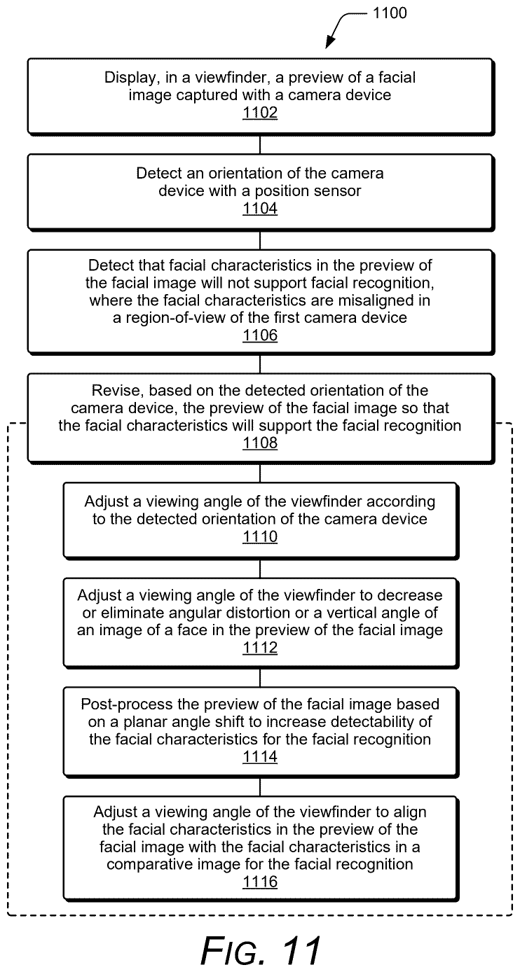

FIG. 10 illustrates example method(s) 1000 for foldable mobile device camera and face detection. The order in which the method is described is not intended to be construed as a limitation, and any number or combination of the described method operations may be performed in any order to perform a method, or an alternate method.

At 1002, a preview of a facial image captured with a first camera device is displayed. For example, the viewfinder 414 displays image previews, such as an image preview 416 of a facial image 412. The image preview 416 of a facial image 412 is displayed on a display screen of the mobile device 400, before a user initiates to capture the facial image. In a mobile phone device, for example, the viewfinder 414 may be implemented as a software and/or hardware component of the display screen of the mobile phone device.

At 1004, it is detected that facial characteristics in the preview of the facial image will not support facial recognition, where the facial characteristics are too small for facial recognition or are misaligned in a region-of-view of the first camera device. For example, the image detection controller 402 detects that the facial characteristics 422 in an image preview 416 of a facial image 412 are too small for the facial recognition 420. Similarly, the image detection controller 402 detects that a face in the image preview 416 of a facial image 412 is misaligned in a region-of-view of the main camera device 406.

At 1006, the preview of the facial image is revised so that the facial characteristics will support the facial recognition. For example, the image detection controller 402 applies one or more techniques to revise an image preview 416 of a facial image 412 so that the facial characteristics 422 will support facial recognition 420 by the security module 418. In implementations, the image detection controller 402 can apply a viewing angle adjustment 426, apply a preview zoom-in 428, and/or apply image post-processing 430. The image preview of the facial image can be revised according to any one or more of the following described method actions 1008-1012.

At 1008, an updated preview of the facial image is captured with a second camera device having a wider field-of-view than the first camera device. For example, the secondary, ultrawide camera device 408 is used to capture an updated image preview 416 of a facial image 412. With the wider field-of-view of the ultrawide camera device 408, the facial image 412 is better aligned in the viewfinder 414 so that the facial characteristics 422 are detectable in the updated image preview of the facial image, and support the facial recognition

At 1010, the preview of the facial image is zoomed-in to increase detectability of the facial characteristics for the facial recognition. For example, image detection controller 402 detects that the facial characteristics 422 in an image preview 416 of facial image 412 are too small for the facial recognition, which will likely result in unsuccessful facial recognition 420 by the security module 418. The image detection controller 402 applies the preview zoom-in 428 of the facial image 412, and the zoomed-in image preview increases detectability of the facial characteristics 422 for the facial recognition.

At 1012, an orientation of the zoomed-in preview of the facial image is post-processed based on a planar angle shift to increase the detectability of the facial characteristics for the facial recognition. For example, the image detection controller 402 applies the image post-processing 430 for an orientation of the zoomed-in preview of the facial image 412 based on a planar angle shift to increase detectability of the facial characteristics 422 for the facial recognition 420.

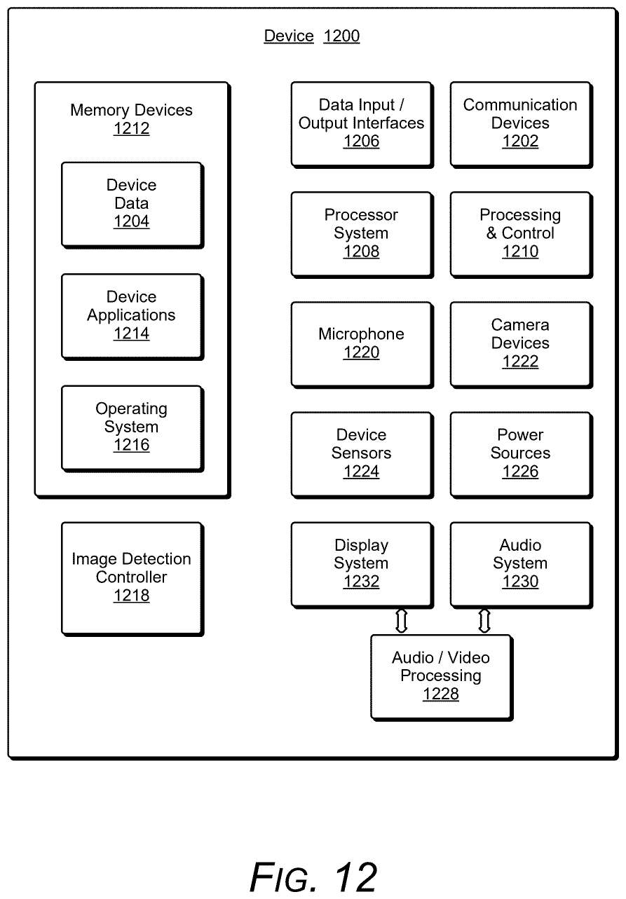

FIG. 11 illustrates example method(s) 1100 for foldable mobile device camera and face detection. The order in which the method is described is not intended to be construed as a limitation, and any number or combination of the described method operations may be performed in any order to perform a method, or an alternate method.

At 1102, a preview of a facial image captured with a camera device is displayed in a viewfinder. For example, the viewfinder 414 displays image previews, such as an image preview 416 of a facial image 412. The image preview 416 of a facial image 412 is displayed on a display screen of the mobile device 400, before a user initiates to capture the facial image. In a mobile phone device, for example, the viewfinder 414 may be implemented as a software and/or hardware component of the display screen of the mobile phone device.

At 1104, an orientation of the camera device is detected. For example, the image detection controller 402 obtains or receives an indication of the orientation 434 of the mobile device 400 and/or the orientation 434 of the main camera device 406 when a facial image 412 is captured, as detected by the position sensor 432. At 1106, it is detected that facial characteristics in the preview of the facial image will not support facial recognition, where the facial characteristics are misaligned in a region-of-view of the camera device. For example, the image detection controller 402 detects that a face in the image preview 416 of the facial image 412 is misaligned in a region-of-view of the main camera device 406,

At 1108, the preview of the facial image is revised, based on the detected orientation of the camera device, so that the facial characteristics will support the facial recognition. For example, the image detection controller 402 revises the image preview 416 of a facial image 412 based on the detected device orientation (e.g., the orientation of the mobile device 400 and/or the orientation of the camera device) so that the facial characteristics will support the facial recognition. The image preview 416 of the facial image can be revised, based on the detected orientation of the camera device, according to any one or more of the following described method actions 1110-1116.

At 1110, a viewing angle of the viewfinder is adjusted according to the detected orientation of the camera device. For example, the image detection controller adjusts a viewing angle of the viewfinder 414 according to the detected orientation 434 of the mobile device. In implementations, the position sensor 432 detects the device orientation 434 of the mobile device 400 and/or the device orientation 434 of a camera device relative to horizontal. The image detection controller 402 can then adjust a viewing angle of the viewfinder 414 to approximately correlate with the detected orientation of the mobile device and/or the camera device.

At 1112, a viewing angle of the viewfinder is adjusted to decrease or eliminate angular distortion or a vertical angle of an image of a face in the preview of the facial image. For example, the image detection controller adjusts a viewing angle of the viewfinder 414 to decrease or eliminate angular distortion of the face in the image preview of the facial image.

At 1114, the preview of the facial image is post-processed based on a planar angle shift to increase detectability of the facial characteristics for the facial recognition. For example, the image detection controller applies the image post-processing 430 to post-process the image preview 416 of the facial image 412 based on a planar angle shift to increase detectability of the facial characteristics 422 for the facial recognition 420 performed by the security module 418.

At 1116, a viewing angle of the viewfinder is adjusted to align the facial characteristics in the preview of the facial image with the facial characteristics in a comparative image for the facial recognition. For example, the image detection controller applies the viewing angle adjustment 426 to adjust a viewing angle of the viewfinder 414 to align the facial characteristics 422 in the image preview 416 of the facial image 412 with the facial characteristics in the comparative image 424 for the facial recognition 420 by the security module 418.

FIG. 12 illustrates various components of an example device 1200, which can implement aspects of the techniques and features for foldable mobile device camera and face detection, as described herein. The example device 1200 may be implemented as any of the devices described with reference to the previous FIG. 1-11, such as any type of a wireless device, mobile device, mobile phone, flip phone, client device, companion device, display device, tablet, computing, communication, entertainment, gaming, media playback, and/or any other type of computing and/or electronic device. For example, the mobile device 400 described with reference to FIGS. 1-11 may be implemented as the example device 1200.

The example device 1200 can include various, different communication devices 1202 that enable wired and/or wireless communication of device data 1204 with other devices. The device data 1204 can include any of the various devices data and content that is generated, processed, determined, received, stored, and/or communicated from one computing device to another. Generally, the device data 1204 can include any form of audio, video, image, graphics, and/or electronic data that is generated by applications executing on a device. The communication devices 1202 can also include transceivers for cellular phone communication and/or for any type of network data communication.

The example device 1200 can also include various, different types of data input/output (I/O) interfaces 1206, such as data network interfaces that provide connection and/or communication links between the devices, data networks, and other devices. The data I/O interfaces 1206 may be used to couple the device to any type of components, peripherals, and/or accessory devices, such as a computer input device that may be integrated with the example device 1200. The I/O interfaces 1206 may also include data input ports via which any type of data, information, media content, communications, messages, and/or inputs may be received, such as user inputs to the device, as well as any type of audio, video, image, graphics, and/or electronic data received from any content and/or data source.

The example device 1200 includes a processor system 1208 of one or more processors (e.g., any of microprocessors, controllers, and the like) and/or a processor and memory system implemented as a system-on-chip (SoC) that processes computer-executable instructions. The processor system 1208 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1210. The example device 1200 may also include any type of a system bus or other data and command transfer system that couples the various components within the device. A system bus can include any one or combination of different bus structures and architectures, as well as control and data lines.

The example device 1200 also includes memory and/or memory devices 1212 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1212 include volatile memory and non-volatile memory, fixed and removable media devices, and any suitable memory device or electronic data storage that maintains data for computing device access. The memory devices 1212 can include various implementations of random-access memory (RAM), read-only memory (ROM), flash memory, and other types of storage media in various memory device configurations. The example device 1200 may also include a mass storage media device.

The memory devices 1212 (e.g., as computer-readable storage memory) provide data storage mechanisms, such as to store the device data 1204, other types of information and/or electronic data, and various device applications 1214 (e.g., software applications and/or modules). For example, an operating system 1216 may be maintained as software instructions with a memory device 1212 and executed by the processor system 1208 as a software application. The device applications 1214 may also include a device manager, such as any form of a control application, software application, signal-processing and control module, code that is specific to a particular device, a hardware abstraction layer for a particular device, and so on.

In this example, the device 1200 includes an image detection controller 1218 that implements various aspects of the described features and techniques described herein. The image detection controller 1218 may be implemented with hardware components and/or in software as one of the device applications 1214, such as when the example device 1200 is implemented as the mobile device 400, the foldable mobile device 504, the foldable mobile device 604, and/or the foldable mobile device 704 described with reference to FIGS. 1-11. An example of the image detection controller 1218 is the image detection controller 402 implemented by the mobile device 400, such as a software application and/or as hardware components in the mobile device. In implementations, the image detection controller 1218 may include independent processing, memory, and logic components as a computing and/or electronic device integrated with the example device 1200.

The example device 1200 can also include a microphone 1220 (e.g., to capture audio and/or an audio recording) and/or camera devices 1222 (e.g., to capture digital images and/or video images), as well as device sensors 1224, such as may be implemented as components of an inertial measurement unit (IMU). The device sensors 1224 may be implemented with various sensors, such as a gyroscope, an accelerometer, a gravity sensor, and/or other types of motion sensors to sense motion of the device. The device sensors 1224 can generate sensor data vectors having three-dimensional parameters (e.g., rotational vectors in x, y, and z-axis coordinates) indicating location, position, acceleration, rotational speed, and/or orientation of the device. The example device 1200 can also include one or more power sources 1226, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1200 can also include an audio and/or video processing system 1228 that generates audio data for an audio system 1230 and/or generates display data for a display system 1232. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1200. Alternatively, the audio system and/or the display system are external, peripheral components to the example device.

Although implementations for foldable mobile device camera and face detection have been described in language specific to features and/or methods, the appended claims are not necessarily limited to the specific features or methods described. Rather, the specific features and methods are disclosed as example implementations for foldable mobile device camera and face detection, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising: a camera device configured to capture a facial image; a viewfinder of the camera device configured to display a preview of the facial image; a position sensor configured to detect an orientation of the mobile device; at least one processor coupled with at least one memory to implement an image detection controller configured to detect that facial characteristics in the preview of the facial image will not support facial recognition; and revise, based on the detected orientation of the mobile device, the preview of the facial image so that the facial characteristics will support the facial recognition.

Alternatively, or in addition to the above-described mobile device, any one or combination of: the facial recognition is a class 3 biometric with a security level for one or more of unlocking the mobile device or accessing a secure application on the mobile device. The image detection controller is configured to detect that a face in the preview of the facial image is misaligned in a region-of-view of the camera device; and adjust a viewing angle of the viewfinder according to the detected orientation of the mobile device. The position sensor is configured to detect the orientation of the mobile device relative to horizontal; and the image detection controller is configured to adjust a viewing angle of the viewfinder to approximately correlate with the detected orientation of the mobile device. The image detection controller is configured to detect that a face in the preview of the facial image is misaligned in a region-of-view of the camera device; and adjust a viewing angle of the viewfinder to at least one of decrease or eliminate angular distortion of the face in the preview of the facial image. The image detection controller is configured to post-process the preview of the facial image based on a planar angle shift to increase detectability of the facial characteristics for the facial recognition. The image detection controller is configured to detect a vertical image of a face in the preview of the facial image; and adjust a viewing angle of the viewfinder to at least one of decrease or eliminate a vertical angle of the vertical image of the face in the preview of the facial image. The image detection controller is configured to post-process the preview of the facial image based on a planar angle shift to increase detectability of the facial characteristics for the facial recognition. The image detection controller is configured to adjust a viewing angle of the viewfinder to align the facial characteristics in the preview of the facial image with the facial characteristics in a comparative image for the facial recognition. A foldable housing configured to fold the mobile device from an opened form factor to a folded form factor; and wherein the camera device is configured to capture images in the folded form factor of the mobile device, and the camera device is operational as a rear-facing camera in the opened form factor of the mobile device.

A method, comprising: displaying, in a viewfinder, a preview of a facial image captured with a camera device; detecting an orientation of the camera device; detecting that facial characteristics in the preview of the facial image will not support facial recognition; and revising, based on the detected orientation of the camera device, the preview of the facial image so that the facial characteristics will support the facial recognition.

Alternatively, or in addition to the above-described method, any one or combination of: the method further comprising detecting that a face in the preview of the facial image is misaligned in a region-of-view of the camera device; and adjusting a viewing angle of the viewfinder according to the detected orientation of the camera device. The method further comprising detecting that a face in the preview of the facial image is misaligned in a region-of-view of the camera device; and adjusting a viewing angle of the viewfinder to at least one of decrease or eliminate angular distortion of the face in the preview of the facial image. The method further comprising post-processing the preview of the facial image based on a planar angle shift to increase detectability of the facial characteristics for the facial recognition. The method further comprising detecting a vertical image of a face in the preview of the facial image; and adjusting a viewing angle of the viewfinder to at least one of decrease or eliminate a vertical angle of the vertical image of the face in the preview of the facial image. The method further comprising post-processing the preview of the facial image based on a planar angle shift to increase detectability of the facial characteristics for the facial recognition. The method further comprising adjusting a viewing angle of the viewfinder to align the facial characteristics in the preview of the facial image with the facial characteristics in a comparative image for the facial recognition.

A system, comprising: a viewfinder configured to display a preview a facial image captured with a camera device; an image detection controller configured to: detect that facial characteristics in the preview of the facial image will not support facial recognition; and adjust a viewing angle of the viewfinder according to an orientation of the camera device.

Alternatively, or in addition to the above-described system, any one or combination of: a position sensor configured to detect the orientation of the camera device relative to horizontal; and wherein the image detection controller is configured to adjust the viewing angle of the viewfinder to approximately correlate with the detected orientation of the camera device. The image detection controller is configured to adjust the viewing angle of the viewfinder to align the facial characteristics in the preview of the facial image with the facial characteristics in a comparative image for the facial recognition.

1. A mobile device, comprising:
a camera device configured to capture a facial image;
a viewfinder of the camera device configured to display a preview of the facial image;
a position sensor configured to detect an orientation of the mobile device;
at least one processor coupled with at least one memory to implement an image detection controller configured to:
detect that facial characteristics in the preview of the facial image will not support facial recognition; and
revise, based on the detected orientation of the mobile device, the preview of the facial image so that the facial characteristics will support the facial recognition.

2. The mobile device of claim 1, wherein the facial recognition is a class 3 biometric with a security level for one or more of unlocking the mobile device or accessing a secure application on the mobile device.

3. The mobile device of claim 1, wherein the image detection controller is configured to:
detect that a face in the preview of the facial image is misaligned in a region-of-view of the camera device; and
adjust a viewing angle of the viewfinder according to the detected orientation of the mobile device.

4. The mobile device of claim 1, wherein:
the position sensor is configured to detect the orientation of the mobile device relative to horizontal; and
the image detection controller is configured to adjust a viewing angle of the viewfinder to approximately correlate with the detected orientation of the mobile device.

5. The mobile device of claim 1, wherein the image detection controller is configured to:
detect that a face in the preview of the facial image is misaligned in a region-of-view of the camera device; and
adjust a viewing angle of the viewfinder to at least one of decrease or eliminate angular distortion of the face in the preview of the facial image.

6. The mobile device of claim 5, wherein the image detection controller is configured to post-process the preview of the facial image based on a planar angle shift to increase detectability of the facial characteristics for the facial recognition.

7. The mobile device of claim 1, wherein the image detection controller is configured to:
detect a vertical image of a face in the preview of the facial image; and
adjust a viewing angle of the viewfinder to at least one of decrease or eliminate a vertical angle of the vertical image of the face in the preview of the facial image.

8. The mobile device of claim 7, wherein the image detection controller is configured to post-process the preview of the facial image based on a planar angle shift to increase detectability of the facial characteristics for the facial recognition.

9. The mobile device of claim 1, wherein the image detection controller is configured to adjust a viewing angle of the viewfinder to align the facial characteristics in the preview of the facial image with the facial characteristics in a comparative image for the facial recognition.

10. The mobile device of claim 1, further comprising:
a foldable housing configured to fold the mobile device from an opened form factor to a folded form factor; and
wherein the camera device is configured to capture images in the folded form factor of the mobile device, and the camera device is operational as a rear-facing camera in the opened form factor of the mobile device.

11. A method, comprising:
displaying, in a viewfinder, a preview of a facial image captured with a camera device;
detecting an orientation of the camera device;
detecting that facial characteristics in the preview of the facial image will not support facial recognition; and
revising, based on the detected orientation of the camera device, the preview of the facial image so that the facial characteristics will support the facial recognition.

12. The method of claim 11, further comprising:
detecting that a face in the preview of the facial image is misaligned in a region-of-view of the camera device; and
adjusting a viewing angle of the viewfinder according to the detected orientation of the camera device.

13. The method of claim 11, further comprising:
detecting that a face in the preview of the facial image is misaligned in a region-of-view of the camera device; and
adjusting a viewing angle of the viewfinder to at least one of decrease or eliminate angular distortion of the face in the preview of the facial image.

14. The method of claim 13, further comprising:
post-processing the preview of the facial image based on a planar angle shift to increase detectability of the facial characteristics for the facial recognition.

15. The method of claim 11, further comprising:
detecting a vertical image of a face in the preview of the facial image; and
adjusting a viewing angle of the viewfinder to at least one of decrease or eliminate a vertical angle of the vertical image of the face in the preview of the facial image.

16. The method of claim 15, further comprising:
post-processing the preview of the facial image based on a planar angle shift to increase detectability of the facial characteristics for the facial recognition.

17. The method of claim 11, further comprising:
adjusting a viewing angle of the viewfinder to align the facial characteristics in the preview of the facial image with the facial characteristics in a comparative image for the facial recognition.

18. A system, comprising:
a viewfinder configured to display a preview a facial image captured with a camera device;
an image detection controller configured to:
detect that facial characteristics in the preview of the facial image will not support facial recognition; and
adjust a viewing angle of the viewfinder according to an orientation of the camera device.

19. The system of claim 18, further comprising:
a position sensor configured to detect the orientation of the camera device relative to horizontal; and
wherein the image detection controller is configured to adjust the viewing angle of the viewfinder to approximately correlate with the detected orientation of the camera device.

20. The system of claim 18, wherein the image detection controller is configured to adjust the viewing angle of the viewfinder to align the facial characteristics in the preview of the facial image with the facial characteristics in a comparative image for the facial recognition.
